(19) United States
(12) Patent Application Publication
(10) Pub. No.: US 2009/0187003 A1
(43) Pub. Date: Jul. 23, 2009

(54) THERMOSETTING RESIN, THERMOSETTING COMPOSITION CONTAINING SAME, AND MOLDED PRODUCT OBTAINED FROM SAME

(76) Inventors: Yuji Eguchi, Ibaraki (JP); Kazuo Doyama, Ibaraki (JP); Hatsuo Ishida, Ibaraki (JP)

Correspondence Address: SUGHRUE MION, PLLC, 2100 PENNSYLVANIA AVENUE, N.W., SUITE 800, WASHINGTON, DC, 20037, US

(21) Appl. No.: 12/088,681

(22) PCT Filed: Sep. 25, 2006
(86) PCT No.: PCT/JP2006/318976

§ 371 Date: Mar. 29, 2008

(30) Foreign Application Priority Data
Sep. 29, 2005 (JP) 2005-284226
Feb. 23, 2006 (JP) 2006-047342
Feb. 28, 2006 (JP) 2006-054104

(51) Int. Cl. C08G 65/00

(52) U.S. Cl. 528/403

(57) ABSTRACT

An object of the invention is to provide a thermosetting resin excellent in dielectric characteristics and heat resistance, and to provide a thermosetting composition comprising the thermosetting resin, as well as a molded product, substrate material for electronic devices and so forth obtained from the thermosetting resin. The present invention provides a thermosetting resin having a dihydrobenzoxazine ring structure represented by formula (I) in a main chain thereof, a thermosetting composition comprising the thermosetting resin, as well as a molded product, substrate material for electronic devices and so forth obtained from the thermosetting resin.

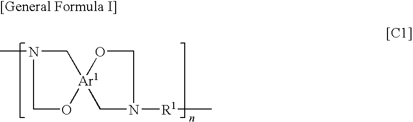

(in formula (I), Ar¹ represents a tetravalent aromatic group, R¹ is a hydrocarbon group having a fused alicyclic structure, and n represents an integer from 2 to 500).

### CROSS-REFERENCES

The entire disclosure of Japanese Patent Application No. 2005-284226, filed on Sep. 29, 2005, No. 2006-047342, filed on Feb. 23, 2006, and No. 2006-054104, filed on Feb. 28, 2006, is expressly incorporated by reference herein.

### BACKGROUND

The present invention relates to a thermosetting resin having excellent dielectric characteristics of low permittivity and low dielectric loss, and at the same time, excellent heat resistance and pliability, and relates also to a thermosetting composition comprising the thermosetting resin, and to a molded product, cured product, cured molded product, substrate material for electronic devices, and electronic device obtained from the thermosetting resin.

Thermosetting resins such as phenol resins, melamine resins, epoxy resins, unsaturated polyester resins, bismaleimide resins and the like are used in a wide variety of industrial fields on account of, for instance, their excellent water resistance, chemical resistance, heat resistance, mechanical strength, reliability and the like that derive from their thermosetting character.

Thermosetting resins, however, have also drawbacks, for instance in that, during curing, phenolic resins and melamine resins give rise to volatile byproducts, and in that epoxy resins and unsaturated polyester resins exhibit deficient flame retardancy, while bismaleimide resins are extremely expensive.

In order to overcome these drawbacks, research has been conducted on dihydrobenzoxazine compounds comprising a dihydrobenzoxazine ring structure in the molecule, an on dihydrobenzoxazine polymers comprising a dihydrobenzoxazine ring structure in a main chain thereof (dihydrobenzoxazine compounds and dihydrobenzoxazine polymers are referred to hereinafter as benzoxazine polymers, for short).

In benzoxazine polymers, the dihydrobenzoxazine rings in the polymer undergo a ring-opening polymerization reaction, and hence do not give rise to problematic volatile components.

In addition to the above intrinsic characteristics of thermosetting resins, benzoxazine polymers are resins having various advantages such as excellent storability, and relatively low viscosity when molten, while affording a broad degree of freedom as regards molecular design.

Meanwhile, enhanced signal transmission speeds and high-frequency characteristics, achieved through improved dielectric characteristics (lower permittivities and lower dielectric losses), are required at present to cope with increasing density (miniaturization) of electronic devices and components, as well as with higher signal transmission speeds.

In addition to lower permittivity and lower dielectric loss, a substrate material for electronic devices must also meet the requirements of having enough heat resistance to withstand soldering, while exhibiting at the same time enough pliability to preclude the occurrence of cracks or the like caused by internal strain or external stresses. The requirement of pliability is even more stringent in the case of, for instance, flexible substrates.

As thermosetting resin raw materials having such superior dielectric characteristics there can be used known benzoxazine polymers represented by formulas (1) and (2) below (for instance, refer to Non Patent Document 1 and Non Patent Document 2)

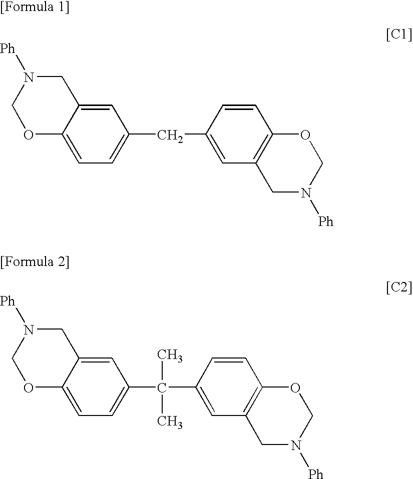

The resins obtained through ring-opening polymerization of the benzoxazine rings in such benzoxazine polymers do not give rise to volatile components during curing, and exhibit excellent flame retardancy and water resistance.

There have also been proposed, for instance, thermosetting resins having a dihydrobenzoxazine ring structure (refer to Patent Document 1 and Patent Document 2), an aryl-substituted benzoxazine (refer to Non Patent Document 3), as well as polybenzoxazine precursors (refer to Non Patent Document 4).

Patent Document 1: Japanese Unexamined Patent Application Laid-open No. H08-183835

### Patent Document 2: Japanese Unexamined Patent Application Laid-open No. 2003-64180

Non Patent Document 1: The homepage of Konishi Chemical Industry Co. Ltd., retrieved 29 Jul. 2005, Internet: <URL:http://www.konishi-chem.co.jp/cgi-data/jp/pdf/pdf_{—}2.pdf>
Non Patent Document 2: The homepage of Shikoku Chemicals Corp., retrieved 29 Jul. 2005, <URL:http://www.shikoku.co.jp/chem/labo/benzo/main.html>
Non Patent Document 3: “The curing reaction of 3-aryl substituted benzoxazine” High Perform. Polym. 12 (2000) 237-246
Non Patent Document 4: “Synthesis and thermal cure of high molecular weight polybenzoxazine precursors and the properties of the thermosets”, [Available online 8 Nov. 2005], <URL:1159164768086_{—}0>

Although the above benzoxazine polymers have excellent dielectric characteristics among thermosetting resins, even yet higher dielectric characteristics are required to respond to the ever higher performance of electronic devices and components. For instance, although the Non Patent Document 1 describes a material having a permittivity of 4.4, and the Non Patent Document 2 describes a benzoxazine resin having a permittivity of 3.44 and a dielectric tangent of 0.0066, as resin materials of multilayer boards comprised in an IC package such as a memory, a logic processor or the like, materials having yet lower permittivities and lower dielectric tangents are still required.

Technology trends also point to ongoing demand for lower dielectric losses in the future. Specifically, although dielectric losses tend ordinarily to be proportional to the frequency and to the dielectric tangent of the material, frequencies used in electronic devices and components are steadily increasing, and hence there is a pressing demand for materials having yet lower dielectric tangents.

Solder heat resistance is a characteristic required from materials used around boards. Requirements regarding heat resistance are also becoming more stringent than hitherto on account of the need to comply with the current and future use of lead-free solders. In ordinary material design, heat resistance tends to be sacrificed in a structure having superior dielectric characteristics, for instance by using aliphatic-backbone benzoxazines. Conversely, permittivity tends to be sacrificed in a structure having superior heat resistance, for instance by using aromatic-backbone benzoxazines.

Thus, combining both dielectric characteristics and heat resistance was difficult in conventional benzoxazine polymers.

Although enhanced pliability during molding is also desirable, ordinary material design tended to sacrifice heat resistance when striving for a structure excellent in pliability, it being thus difficult to combine simultaneously dielectric characteristics, heat resistance and pliability.

### SUMMARY

Thus, it is an object of the present invention to provide a thermosetting resin having dielectric characteristics, in particular permittivity and dielectric loss, that are further improved vis-à-vis conventional thermosetting resins, and having also improved heat resistance, and to provide a thermosetting composition comprising the thermosetting resin, as well as a molded product, cured product, cured molded product, substrate material for electronic devices, and electronic device obtained from the thermosetting resin.

Another object of the present invention is to provide a thermosetting resin that combines heat resistance, pliability and the superior dielectric characteristics of a dihydrobenzoxazine ring-opening polymerization composition, and to provide a thermosetting composition comprising the thermosetting resin, as well as a molded product, cured product, cured molded product, substrate material for electronic devices, and electronic device obtained from the thermosetting resin.

As a result of diligent research, the inventors found out that a specific benzoxazine polymer allows achieving the above goal. The present invention is based on such a finding. Specifically, the present invention is as follows.

1. A thermosetting resin having a dihydrobenzoxazine ring structure represented by formula (I) in a main chain thereof,

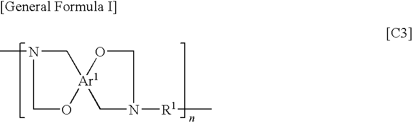

(in formula (I), Ar¹ represents a tetravalent aromatic group, R¹ is a hydrocarbon group having a fused alicyclic structure, and n represents an integer from 2 to 500).

2. The thermosetting resin according to 1, wherein R¹ is a group represented by (i) or (ii),

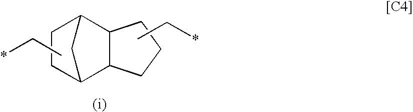

(in formula (I), the * sign represents a bonding site to N; the formula includes cis-trans isomers),

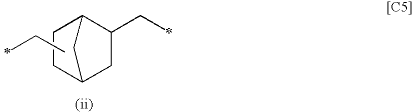

(in formula (II), the * sign represents a bonding site to N; the formula includes cis-trans isomers).

3. The thermosetting resin according to 1, wherein Ar¹ is represented by any of structures (iii), (iv) or (v),

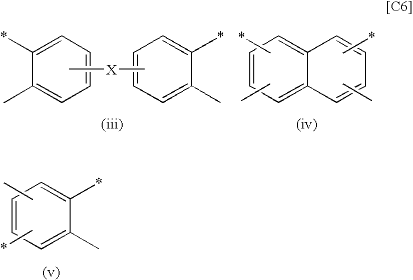

(in formulas (iii) to (v), the * sign represents a bonding site to OH, and the other sign a bonding site to a methylene group at position 4 of an oxazine ring;

hydrogen in the aromatic rings may be substituted with a C₁ to C₁₀ aliphatic hydrocarbon group, alicyclic hydrocarbon group, or a substituted or unsubstituted phenyl group;

in formula (iii), X denotes a direct bond (without any atom or atom groups), or an aliphatic, alicyclic or aromatic hydrocarbon group optionally comprising a heteroelement or functional group).

4. The thermosetting resin according to 3, wherein Ar¹ is represented by the structure (iii) and X in the structure (iii) is at least one selected from group A below,

[C7]
group A:

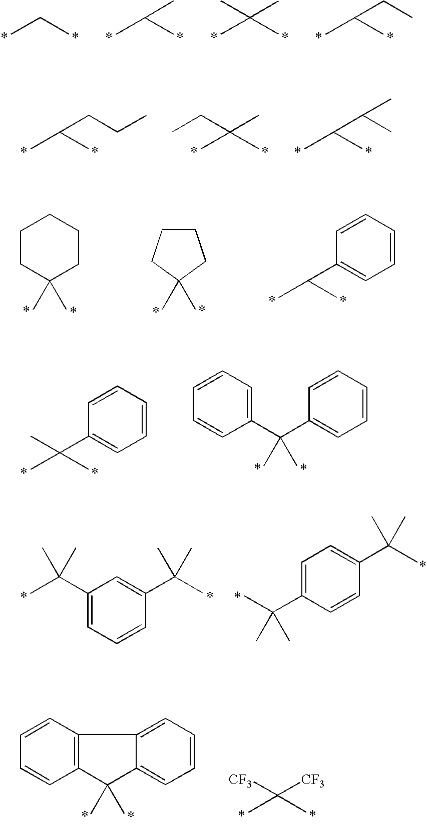

(in the formula, the * sign represents a bonding site to an aromatic ring of the structure (iii)).

5. A thermosetting resin having a dihydrobenzoxazine ring structure represented by formula (II) in a main chain thereof,

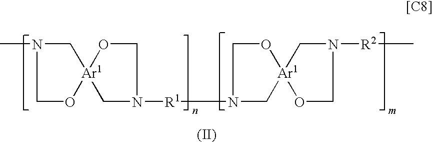

(in formula (II), Ar¹ represents a tetravalent aromatic group, R¹ is a hydrocarbon group having a fused alicyclic structure, R² is an aliphatic hydrocarbon group, and m+n represents an integer from 2 to 500.)

6. The thermosetting resin according to 5, wherein R² is a linear aliphatic hydrocarbon group.

7. The thermosetting resin according to 5, wherein R² is a C₆ to C₁₂ aliphatic hydrocarbon group.

8. The thermosetting resin according to 5, wherein R¹ is a group represented by (i) or (ii),

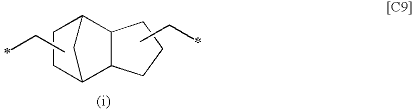

(in formula (I), the * sign represents a bonding site to N; the formula includes cis-trans isomers),

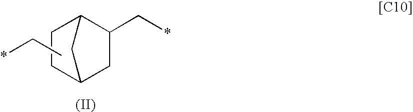

(in formula (II), the * sign represents a bonding site to N; the formula includes cis-trans isomers).

9. The thermosetting resin according to 5, wherein Ar¹ is represented by any of structures (iii), (iv) or (v),

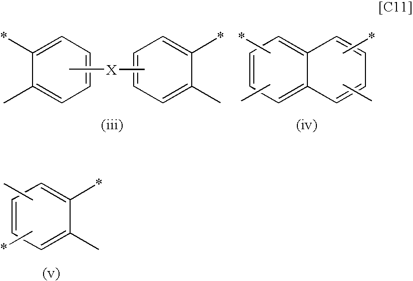

(in formulas (iii) to (v), the * sign represents a bonding site to OH, and the other sign a bonding site to a methylene group at position 4 of an oxazine ring;

hydrogen in the aromatic rings may be substituted with a C₁ to C₁₀ aliphatic hydrocarbon group, alicyclic hydrocarbon group, or a substituted or unsubstituted phenyl group;

in formula (iii), X denotes a direct bond (without any atom or atom groups), or an aliphatic, alicyclic or aromatic hydrocarbon group optionally comprising a heteroelement or functional group).

10. The thermosetting resin according to 9, wherein Ar¹ is represented by the structure (iii) and X in the structure (iii) is at least one selected from group A below,

[C12]
group A:

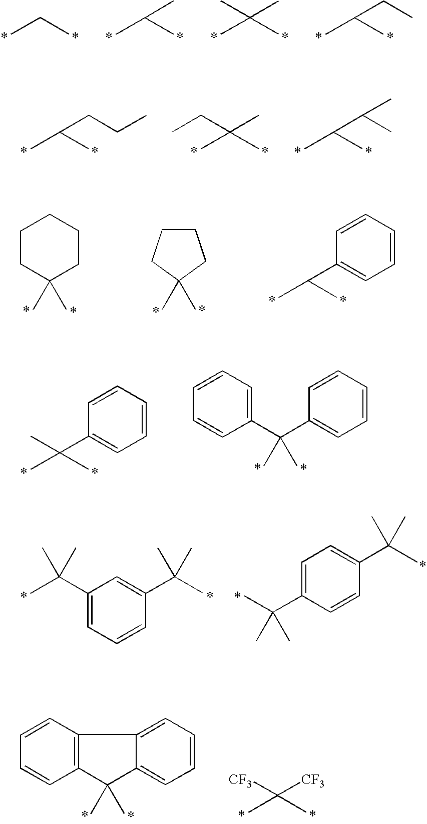

(in the formula, the * sign represents a bonding site to an aromatic ring of the structure (iii)).

11. A thermosetting resin having a dihydrobenzoxazine ring structure in a main chain thereof, obtained by reacting:

(1) an aliphatic diamine represented by NH₂—R²—NH₂ (R² is an aliphatic hydrocarbon group);

(2) OH—Ar²—OH (Ar² is an aromatic group);

(3) NH₂—R¹—NH₂ (R¹ is a hydrocarbon group having a fused alicyclic structure); and

(4) an aldehyde compound.

12. A thermosetting composition comprising at least the thermosetting resin according to any one of 1, 5 and 11.

13. The thermosetting composition according to 12, comprising a compound having at least one dihydrobenzoxazine structure in the molecule.

14. A molded product obtained from the thermosetting resin according to any one of 1, 5 and 11.

15. A molded product obtained from the thermosetting composition according to 12.

16. A cured product obtained by curing the thermosetting resin according to any one of 1, 5 and 11.

17. A cured product obtained by curing the thermosetting composition according to 12.

18. A cured molded product obtained by curing the molded product according to 14.

19. A cured molded product obtained by curing the molded product according to 15.

The present invention provides thus a thermosetting resin remarkably superior in heat resistance and in dielectric characteristics such as permittivity and dielectric loss.

The present invention provides also a thermosetting resin that combines dielectric characteristics, heat resistance and pliability, as well as a thermosetting composition, molded product and the like comprising the thermosetting resin.

### DETAILED DESCRIPTION

The present invention is explained in detail next based on preferred embodiments thereof.

Thermosetting Resin

The thermosetting resin of the present invention comprises a polymer having a dihydrobenzoxazine represented by formula (I) in a main chain thereof

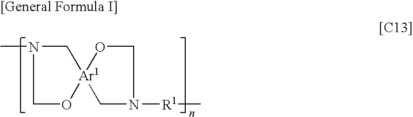

(in formula (I), Ar¹ represents a tetravalent aromatic group, R¹ is a hydrocarbon group having a fused alicyclic structure, and n represents an integer from 2 to 500.)

In the present description, “fused alicyclic structure” corresponds to the structure of a bridged cyclic hydrocarbon (according to “Handbook of Organic Compound Nomenclature”, Kagakudojin) comprising two or more rings of aliphatic hydrocarbons sharing two or more atoms. For specific examples of such a structure, refer to [Formula 4] and [Formula 5] in the description.

The thermosetting resin of the present invention comprises such a structure, and hence combines dielectric characteristics and heat resistance. The thermosetting resin of the present invention comprises a polymer as described above, and hence has excellent workability into films, sheets, or the like, as well as sufficient moldability also before curing.

Thanks to the dihydrobenzoxazine ring-opening polymerization reaction, the thermosetting resin of the present invention can be cured without giving rise to harmful volatile substances.

In formula (I), R¹ has preferably 8 or more carbon atoms, with a view to effectively lowering permittivity.

In formula (I), R¹ has preferably a fused ring structure, with a view to affording enhanced heat resistance, in addition to the above characteristics.

The thermosetting resin of the present invention, having a dihydrobenzoxazine ring structure in a main chain thereof, is obtained by reacting (1) an aliphatic diamine represented by NH₂—R²—NH₂ (R² is an aliphatic hydrocarbon group), (2) OH—Ar²—OH (Ar² is an aromatic group), (3) NH₂—R¹—NH₂ (R¹ is a hydrocarbon group having a fused alicyclic structure), and (4) an aldehyde compound.

As a result, the thermosetting resin of the present invention exhibits superior pliability than is the case when R¹ is an ordinary aliphatic ring. The thermosetting resin of the present invention comprises a polymer such as described above, and hence has excellent workability into films, sheets, or the like, as well as sufficient moldability also before curing.

Thanks to the dihydrobenzoxazine ring-opening polymerization reaction, the thermosetting resin of the present invention can be cured without giving rise to harmful volatile substances.

Preferably, the thermosetting resin is represented by formula (II) below

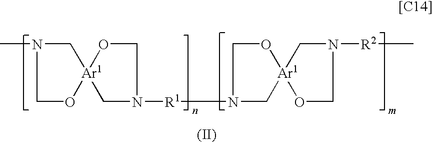

(in formula (II), Ar¹ represents a tetravalent aromatic group, being a part of a dihydrobenzoxazine ring derived from a divalent Ar², and m+n represents an integer from 2 to 500.)

In formula (II), m and n, which denote the degree of polymerization, are the addition mole number of monomeric structural units. In terms of enhancing flow during molding, m+n is preferably an integer from 2 to 500, more preferably from 2 to 100.

The monomeric structural unit having a degree of polymerization n (left unit in formula (II)), and the monomeric structural unit having a degree of polymerization m (right unit in formula (II)) may bond with each other through random polymerization or inter-polymerization. The polymer may also comprise a homopolymer comprising only one of the respective structural units.

In terms of further enhancing pliability, R² in the above aliphatic diamine is preferably a linear aliphatic hydrocarbon group.

Preferably, R² is a C₄ to C₂₄ aliphatic hydrocarbon group.

More preferably, R² is a C₆ to C₁₂ aliphatic hydrocarbon group.

Since R¹ is an alicyclic hydrocarbon group having a fused ring structure, it allows further enhancing heat resistance while affording characteristics such as, for instance, ready availability, reaction rates as well as electric characteristics of the obtained polymer and the eventually obtained cured product.

The electric characteristics of the obtained resin are extremely good when R¹ is a group represented by formula (I) below

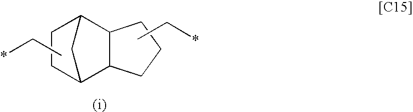

(in formula (I), the * sign represents a bonding site to N. The formula includes cis-trans isomers.)

The electric characteristics of the obtained resin are extremely good when R¹ is a group represented by formula (II) below

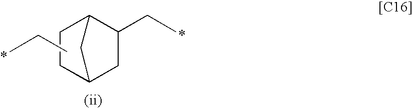

(in formula (II), the * sign represents a bonding site to N. The formula includes cis-trans isomers.)

In terms of, in particular, availability and reactivity, Ar¹, which represents a tetravalent aromatic group, is preferably represented by any one of the structures (iii), (iv) and (v) below

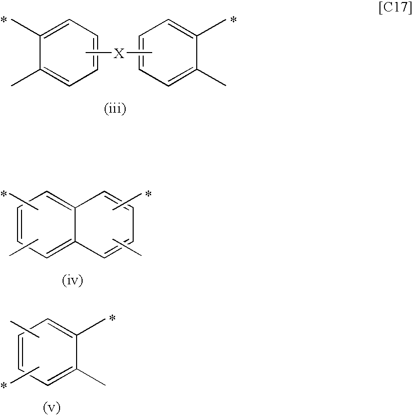

(in formulas (iii) to (v), the * sign represents a bonding site to OH, and the other sign a bonding site to a methylene group at position 4 of an oxazine ring.

Hydrogen in the aromatic rings may be substituted with a C₁ to C₁₀ aliphatic hydrocarbon group, alicyclic hydrocarbon group, or a substituted or unsubstituted phenyl group.

In formula (iii), X denotes a direct bond (without any atom or atom groups), or an aliphatic, alicyclic or aromatic hydrocarbon group optionally comprising a heteroelement or functional group.)

Among the above, the structure represented by formula (iii) is preferred as it facilitates the structural design of resins that meet the required characteristics.

When Ar¹ has the structure (iii), X is yet more preferably at least one selected from group A below.

Such a structure is highly preferred on account of its ready availability and the excellent mechanical and electric characteristics of the polymer.

[C18]
group A:

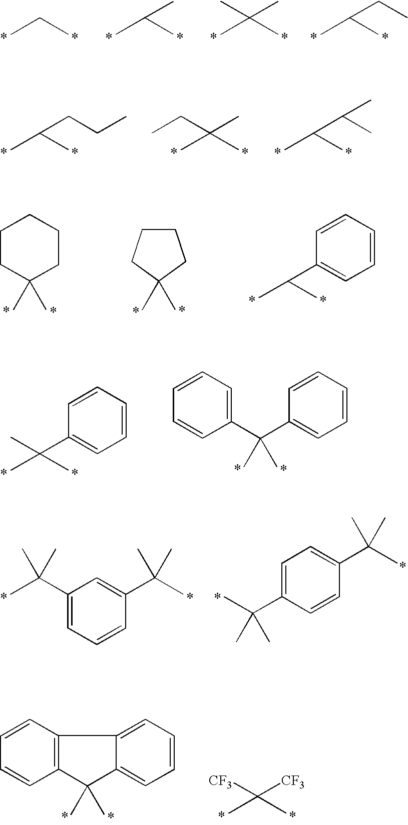

(In the formula, the * sign represents a bonding site to an aromatic ring of the structure (iii).)

Among group A, particularly preferred are structures represented by group B below, on account of the excellent electric characteristics and heat resistance that they afford.

[C19]
group B:

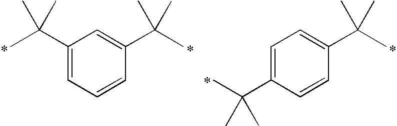

(In the formula, the * sign represents a bonding site to an aromatic ring of the structure (iii).)

In terms of ready availability and electric characteristics of a cured product and heat resistance, Ar¹ is preferably represented by at least one structure selected from group C below.

[C20]
group C:

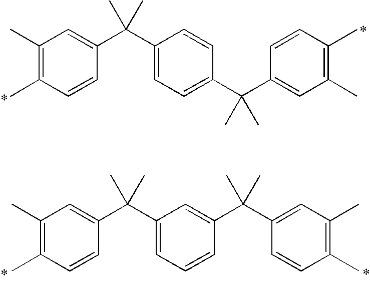

(In each formula, the * sign at the two termini represent a bonding site to OH of (2) and the other sign represents a bonding site to a methylene group at position 4 of the oxazine ring that is the reaction product obtained by reacting (1) to (4).

Hydrogen in the aromatic rings may be substituted with a C₁ to C₁₀ aliphatic hydrocarbon group, alicyclic hydrocarbon group, or a substituted or unsubstituted phenyl group.)

When Ar¹ is at least one selected from the group C, R¹, which represents a hydrocarbon group having an alicyclic structure, is preferably an alicyclic hydrocarbon group having a fused ring structure, as is the case when Ar¹ is represented by the structure of any among (iii), (iv) and (v), and for the same reasons. More preferably, R¹ is a group represented by (i) or (ii).

The thermosetting resin of the present invention is obtained by reacting, through heating in a suitable solvent, (1) an aliphatic diamine represented by NH₂—R²—NH₂ (R² is an aliphatic hydrocarbon group), (2) OH—Ar²—OH (Ar² is an aromatic group), (3) NH₂—R¹—NH₂ (R¹ is a hydrocarbon group having a fused alicyclic structure), and (4) an aldehyde compound.

Although the solvent used in such a synthesis method is not particularly limited, higher degrees of polymerization are likelier to be obtained using solvents to which raw materials such as phenol compounds and amine compounds, as well as the polymers as reaction products, have good solubility. Examples of such solvents include, for instance, aromatic solvents such as toluene, xylene or the like; halogen-type solvents such as chloroform, dichloromethane or the like; or ether solvents such as THF, dioxane or the like.

Reaction temperature and reaction time are not particularly limited. The temperature may range ordinarily from room temperature to about 120° C., and the reaction time may range from several tens of minutes to several hours. In the present invention, the reaction proceeds preferably, in particular, at 30 to 110° C. over 20 minutes to 9 hours, as this affords a polymer exhibiting the function of the thermosetting resin according to the present invention.

There are effective methods for removing the water generated during the reaction out of the system. After the reaction, the polymer can be precipitated through addition of, for instance, an excess of a poor solvent such as methanol or the like. The precipitate is separated and dried to yield the target polymer.

The aliphatic diamine used in the above synthesis method example is not particularly limited, but is preferably, for instance, hexamethylenediamine, 1,8-octanediamine, 1,10-decanediamine, 1,11-undecanediamine, 1,12-dodecanediamine, 1,18-octadecanediamine or the like.

The OH—Ar²—OH (Ar² is an aromatic group) used in the above synthesis method example is not particularly limited, but is preferably a compound in which Ar² has the above preferred structures (iii) to (v) and an OH group is bonded to a * sign while H is bonded to the other sign.

Specific examples of such compounds include structure (iii): compounds having in the molecule two benzene rings, excluding the link X, and wherein one OH group is bonded to one benzene ring, for instance 4,4′-biphenol, 2,2′-biphenol, 4,4′-dihydroxydiphenylether, 2,2′-dihydroxydiphenylether, 4,4′-dihydroxydiphenylmethane, 2,2′-dihydroxydiphenylmethane, bisphenol A, bisphenol S, 4,4′-dihydroxydiphenyl sulfide, 4,4′-dihydroxybenzophenone, 1,1-bis(4-hydroxyphenyl)ethane, 1,1-bis(4-hydroxyphenyl)propane, 1,1-bis(4-hydroxyphenyl)butane, 2,2-bis(4-hydroxyphenyl)butane, 1,1-bis(4-hydroxyphenyl)-2-methylpropane, 1,1-bis(4-hydroxyphenyl)cyclohexane, 1,1-bis(4-hydroxyphenyl)cyclopentane, 1,1-bis(4-hydroxyphenyl)-1-phenylethane, bis(4-hydroxyphenyl)diphenylmethane, 4,4′-[1,4-phenylenebis(1-methyl-ethylidene)]bisphenol (commercially available under the denominations Mitsui Chemicals bisphenol P, and Tokyo Chemicals “α,α″-bis(4-hydroxyphenyl)-1,4-diisopropylbenzene”), 4,4′-[1,3-phenylenebis(1-methyl-ethylidene)]bisphenol (Mitsui Chemicals bisphenol M), 9,9-bis(4-hydroxyphenyl)fluorene, 2,2-bis(4-hydroxyphenyl)hexafluoropropane, 1,3-bis(4-hydroxyphenoxy)benzene, 1,4-bis(3-hydroxyphenoxy)benzene, 2,6-bis((2-hydroxyphenyl)methyl)phenol (compound in which a=1) and the like;

structure (iv): compounds having one naphthalene ring in the molecule and two OH groups bonded to the naphthalene group, for instance, 1,3-dihydroxynaphthalene, 1,4-dihydroxynaphthalene, 1,5-dihydroxynaphthalene, 1,6-dihydroxynaphthalene, 1,7-dihydroxynaphthalene, 2,6-dihydroxynaphthalene, 2,7-dihydroxynaphthalene;

structure (v): compounds having in the molecule one benzene ring, and two OH groups bonded to the benzene ring, for instance 1,2-dihydroxybenzene(catechol), 1,3-dihydroxybenzene(resorcinol), 1,4-dihydroxybenzene(hydroquinone) or the like.

Although the above-illustrated aromatic rings to which OH groups are bonded are unsubstituted except for the OH groups and the link X (in the (iii) structure), any one of the ortho positions of all the OH groups may be a substitutable H, while other sites of the aromatic rings may be substituted with various substituents, for instance C₁ to C₁₀ linear or branched aliphatic hydrocarbon groups and/or alicyclic hydrocarbon groups, or substituted or unsubstituted aromatic groups. When the link X comprises an aromatic ring, the latter may also be substituted with various substituents, for instance C₁ to C₁₀ linear or branched aliphatic hydrocarbon groups and/or alicyclic hydrocarbon groups.

Simples examples of substituted aromatic rings include, for instance, although obviously not limited thereto,

structure (iii): 2,2-bis(4-hydroxy-3-methylphenyl)propane, 2,2-bis(4-hydroxy-3-methyl phenyl)methane,

structure (v): 2-methyl resorcinol, 2,5-dimethyl resorcinol.

During synthesis of the above polymer, there can be used monofunctional and/or trifunctional phenol compounds, provided that the characteristics of the thermosetting resin of the present invention to be obtained are not impaired thereby. The degree of polymerization can be regulated using monofunctional phenols, while using trifunctional phenols allows obtaining branched polymers. Such phenols may be reacted simultaneously with compounds having two phenolic hydroxyl groups in the molecule, or, depending on the reaction sequence, may be made to react through later addition to the reaction system.

When the fused alicyclic hydrocarbon group R¹ in NH₂—R¹—NH₂ (R¹ is a hydrocarbon group having a fused alicyclic structure) used in the above synthesis method example has a fused ring structure, in particular a structure represented by formulas (i) or (ii), the obtained resin exhibits extremely good electric characteristics and heat resistance, and hence such an alicyclic hydrocarbon group is preferably used. Specific examples of compounds in which a primary amino group is bonded to such an alicyclic hydrocarbon group include, for instance, 3(4),8(9)-bis(aminomethyl)tricyclo[5,2,1,0^{2,6}]decane, 2,5(6)-bis(aminomethyl)bicyclo[2,2,1]pentane, or 1,3-diaminoadamantane. A commercial product “TCD Diamine”, from Celanese, can be used as the 3(4),8(9)-bis(aminomethyl)tricyclo[5,2,1,0^{2,6}]decane, while a commercial product “NBDA”, from Mitsui Chemicals, can be used as the 2,5(6)-bis(aminomethyl)bicyclo[2,2,1]pentane. These compounds can be used singly or in various combinations.

The “aliphatic diamine represented by NH₂—R²—NH₂” may be a long-chain or long-chain branched diamine.

Herein there can be used monofunctional or trifunctional amine compounds, provided that the characteristics of the benzoxazine polymer of the present invention are not impaired thereby. The degree of polymerization can be regulated using monofunctional amines, while branched polymers can be obtained by using trifunctional amines. Such amines may be reacted simultaneously with the diamine compounds, or, depending on the reaction sequence, may be made to react through later addition into the reaction system.

The aldehyde compound used in the above synthesis method example is not particularly limited, and may be, preferably, formaldehyde. Such formaldehyde can be used in the form of the polymeric form thereof, paraformaldehyde, or in the in the form of an aqueous solution thereof, as formalin. Other aldehyde compounds that can be used include, for instance, acetaldehyde, propionaldehyde, butyraldehyde or the like.

The thermosetting resin of the present invention comprising a polymer obtained as described above has the remarkably superior characteristic of combining, in particular, dielectric characteristics, heat resistance and pliability. The thermosetting resin, moreover, is excellent in water resistance, chemical resistance, mechanical strength, and reliability, and is unproblematic as regards generation of volatile byproducts during curing, and also in terms of cost. The thermosetting resin of the present invention has also excellent storability, affords a broad degree of freedom as regards molecular design, and can be worked easily into films, sheets or the like, among other advantages.

Thermosetting Composition

The thermosetting composition of the present invention comprises at least the above thermosetting resin.

Preferably, the thermosetting composition further comprises a compound having at least one dihydrobenzoxazine structure in the molecule. Specifically, the thermosetting composition comprises preferably the above thermosetting resin as an essential component, and a compound having at least one dihydrobenzoxazine structure in the molecule, as a auxiliary component. Such a thermosetting composition allows effectively bringing out to the fullest the excellent dielectric characteristics of benzoxazine resins.

In the present specification, the “compound having at least one dihydrobenzoxazine structure in the molecule” is, for instance, a compound as follows.

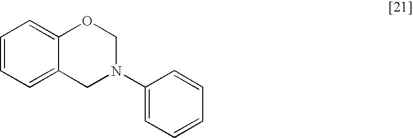

Such a compound can be obtained through a condensation reaction of a compound having a phenolic hydroxyl group in the molecule and H in one of the ortho positions, a compound having a primary amino group in the molecule, and paraformaldehyde. When using a compound having plural phenolic hydroxyl groups in the molecule there is employed a compound having only one primary amino group in the molecule, while when using a compound having plural primary amino groups in the molecule, there is employed a compound having only one phenolic hydroxyl group in the molecule. The compound having at least one dihydrobenzoxazine ring in the molecule may be used singly or in combinations of two or more.

Preferably, the thermosetting composition further comprises another thermosetting resin or thermoplastic resin that differs from the above thermosetting resin. Specifically, a thermosetting composition comprising the above thermosetting resin as an essential component, and another thermosetting resin or thermoplastic resin, as an auxiliary component, is preferable as it results in a molded product having excellent dielectric characteristics, heat resistance and pliability.

Other thermosetting resins or thermoplastic resins that can be used as the auxiliary component include, for instance, epoxy resins, thermosetting modified polyphenylene ether resins, polyimide resins, thermosetting polyimide resins, silicone resins, melamine resins, urea resins, allylic resins, phenol resins, unsaturated polyester resins, bismaleimide system resins, alkyd resins, furan resins, polyurethane resins, aniline resins or the like.

Preferred amongst these, in terms of further enhancing the heat resistance of molded products molded from the thermosetting composition according to the invention, are epoxy resins, phenolic resins, polyimide resins and thermosetting polyimide resins. These other thermosetting resins may be used singly or in combinations of two or more.

Among the above other thermosetting resins or thermoplastic resins, epoxy resins are preferred with a view to enhancing the pliability of the molded product. Specific examples of such epoxy resins include, for instance, glycidyl ether epoxy resins such as bisphenol A epoxy resins, bisphenol F epoxy resins, brominated epoxy resins, biphenyl epoxy resins, substituted bisphenol A epoxy resins, cresol-novolac epoxy resins, trisphenolmethane epoxy resins, dicyclopentadiene epoxy resins, naphthalene epoxy resins, phenolbiphenylene epoxy resins, phenoxy resins or the like; cyclic aliphatic epoxy resins such as 3,4-epoxycyclohexylmethyl-3′,4′-epoxycyclohexanecarboxylate, bis(3,4-epoxycyclohexylmethyl)adipate or the like; glycidylester epoxy resins such as diglycidyl adipate, diglycidyl phthalate epoxy resins or the like; glycidylamine epoxy resins such as diglycidylaniline, aminophenol, aliphatic amine, hydantoin epoxy resins or the like; liquid crystal epoxy resins such as hydroxybenzoate, α-methylstilbene epoxy resins or the like; epoxy resins having functionality such as photosensitivity, degradability or the like; as well as triglycidyl isocyanurate, thiirane-modified epoxy resins or the like. There can also be blended, as the case may require, polyamine curing agents such as aliphatic polyamines, alicyclic polyamines, aromatic polyamines or the like; modified polyamine curing agents such as polyaminoamides, amino-epoxy adducts, Michaels addition polyamines, Mannich reaction products, reaction products with urea or thiourea, ketimines, Schiff bases or the like; basic curing agents such as imidazoles, 2-phenylimidazoline, tertiary amines (DBU or the like), triphenylphosphine, phosphonium salts, organic acid hydrazines or the like; acid anhydride curing agents such as phthalic anhydride, hexahydrophthalic anhydride, tetrahydrophthalic anhydride, trimellitic anhydride, pyromellitic anhydride or the like; as well as polyphenol curing agents such as phenol novolac, xylene novolac, biphenyl novolac, dicylcopentadiene phenol novolac or the like.

Among the above other thermosetting resins or thermoplastic resins, polyimide resins are preferred with a view to enhancing heat resistance and pliability.

The polyimide resins used herein are ordinarily obtained by reacting a dianhydride of a tetracarboxylic acid with a diamine compound. The polyimide resin can be used singly or in combinations of two or more.

Specific examples of tetracarboxylic acid dianhydrides that are one of the raw materials of polyimide resins include, for instance, pyromellitic anhydride, 3,3′,4,4′-biphenyl tetracarboxylic acid dianhydride, 2,3,3′,4′-biphenyl tetracarboxylic acid dianhydride, 2,2′,3,3′-biphenyl tetracarboxylic acid dianhydride, 2,3′,3,4′-benzophenone tetracarboxylic acid dianhydride, 3,3′,4,4′-diphenylsulfone tetracarboxylic acid dianhydride, 3,3′,4,4′-diphenyl ether tetracarboxylic acid dianhydride, 1,4,5,8-naphthalene tetracarboxylic acid dianhydride or the like; cyclopentane-1,2,3,4-tetracarboxylic acid dianhydride or the like. The tetracarboxylic acid dianhydride is not necessarily limited to the foregoing, and other various tetracarboxylic acid dianhydrides may be used. Such tetracarboxylic acid dianhydrides may be used singly or in combinations of two or more.

The diamine compound that can be used as the other raw material of polyimide resins is not limited provided that it has two or more amino groups in the molecule. Specific examples include, for instance, p-phenylenediamine, m-phenylenediamine, 4,4′-diaminodiphenyl ether, 4,4′-diaminodiphenyl methane, 3,4′-diaminodiphenyl methane, 4,4′-diaminodiphenyl sulfone, 3,4′-diaminodiphenyl sulfone, 4,4′-diaminodiphenyl sulfide, 3,4′-diaminodiphenyl sulfide, bis[4-(3-aminophenoxy)phenyl]sulfone, 1,3-bis(4-aminophenoxy)benzene or the like. The diamine compound, however, is not necessarily limited to the foregoing, and various diamine compounds may be used herein. Such diamine compounds may be used singly or in combinations of two or more.

The polyimide resin used in the present invention may be a thermosetting resin or a thermoplastic resin, and may be employed in the form of a solution using a solvent or the like.

The polyamic acid used in the present invention, obtained by reacting the above tetracarboxylic acid dianhydride with a diamine compound, is subsequently dehydrated and subjected to ring opening, through heating, to yield a polyimide resin. Polyamic acid is ordinarily synthesized in a solvent and is applied while in the solvent. The solvent used may be, for instance, N-methylpyrrolidone, dimethylformamide, dimethylacetamide, 1,3-dimethyl-2-imidazolidinone, dimethyl sulfoxide, γ-butyrolactone, 1,2-diethoxyethane, diethylene glycol dimethyl ether, diethylene glycol diethyl ether, cyclohexanone or the like.

The blending ratio of the above thermosetting resin as said essential component (polymer represented by formula (I) having a dihydrobenzoxazine ring structure in a main chain thereof) and the other thermosetting resin or thermoplastic resin as the auxiliary component is preferably of 1/99 to 99/1, more preferably of 5/95 to 95/5 (weight ratio of former to latter).

The thermosetting composition according to the present invention may contain, as needed, various additives such as flame retardants, nucleating agents, antioxidants (antiaging agents), thermostabilizers, light stabilizers, ultraviolet ray absorbents, lubricants, flame-retardancy auxiliary agents, antistatic agents, antifogging agents, bulking agents, softeners, plasticizers, coloring agents and the like. These additives may be used singly or in combinations of two or more. During the preparation of the thermosetting composition according to the present invention there may be used reactive or non-reactive solvents.

Molded Product

The molded product according to the present invention is obtained by molding the above thermosetting resin or a thermosetting composition comprising the thermosetting resin. Since the above-described thermosetting resin has moldability also prior to curing, the molded product of the present invention may be a cured product obtained by curing, through heating, a product already molded prior to curing (cured molded product), or by carrying out simultaneously molding and curing (cured product). Also, the dimensions and shape of the molded product of the present invention are not particularly limited, and may include, for instance, a sheet (plate) shape, a block shape or the like. The molded product may comprise also other sites (for instance an adhesive layer). The molded product, which has thermosetting ability, can be shaped as a film, a plate, pellets or the like.

Any conventionally known curing method can be used herein as the curing method. Curing requires normally heating at about 120 to about 260° C. for several hours, although in some cases mechanical strength is insufficient owing to insufficient curing caused by low heating temperature or insufficient heating time. If the heating temperature is too high and the heating time too long, there may occur, depending on the circumstances, side reactions such as decomposition or the like that impair mechanical strength. Therefore, appropriate conditions are preferably selected in accordance with the type of thermosetting compound that is used.

During curing there may also be added an appropriate curing accelerator. As the curing accelerator there may be used any curing accelerator ordinarily employed during ring-opening polymerization of dihydrobenzoxazine compounds. Such curing accelerators include, for instance, polyfunctional phenols such as catechol and bisphenol A; sulfonic acids such as p-toluenesulfonic acid and p-phenolsulfonic acid; carboxylic acids such as benzoic acid, salicylic acid, oxalic acid and adipic acid; metal complexes such as cobalt (II) acetylacetonate, aluminum (III) acetylacetonate and zirconium (IV) acetylacetonate; metal oxides such as calcium oxide, cobalt oxide, magnesium oxide and iron oxide; calcium hydroxide; imidazole and derivatives thereof; tertiary amines such as diazabicycloundecene, diazabicyclononene and salts thereof; as well as phosphorus-based compounds such as triphenyl phosphine, triphenyl phosphine-benzoquinone derivatives, triphenyl phosphine-triphenyl boron salts, and tetra-phenyl phosphonium-tetraphenyl borate, as well as derivatives thereof. These curing accelerators can be used singly or in combinations of two or more.

The addition amount of curing accelerator is not particularly limited, but if excessive, the dielectric characteristics of the molded product become impaired on account of increased permittivity and/or dielectric tangent, while the mechanical properties may also be negatively affected. Therefore, the curing accelerator is preferably used in an amount no greater than 5 parts by weight, and more preferably no greater than 3 parts by weight, relative to 100 parts by weight of the thermosetting resin.

A molded product obtained from the above thermosetting resin or the above thermosetting composition, and having a fused alicyclic hydrocarbon group represented by R¹ in the polymer structure, can bring out very superior dielectric characteristics, and also excellent heat resistance, thanks mainly to its lower density, derived from larger intermolecular gaps, and to the influence of the steric distribution of the benzene ring in the molecule, among other factors.

When the above thermosetting resin has a more rigid fused-ring alicyclic hydrocarbon group, the obtained molded product can be imparted pliability in addition to the excellent dielectric characteristics that are intrinsic to benzoxazine.

A molded product obtained from the above thermosetting resin or the above thermosetting composition, having in the polymer structure a fused alicyclic hydrocarbon group represented by R¹ and an aliphatic group represented by group R², can bring out very superior dielectric characteristics, and also excellent heat resistance and pliability, thanks mainly to its lower density, derived from larger intermolecular gaps, and thanks to the influence of the steric distribution of the benzene ring in the molecule, among other factors.

The above molded product has excellent reliability, flame retardancy, moldability and appearance on account of the thermosetting properties of the thermosetting resin or the thermosetting composition. Moreover, the molded product has a high glass transition temperature (Tg), and hence can be used at stress sites and/or mobile members. The molded product does not give rise to volatile byproducts during polymerization, and is hence preferable in health terms, as no such volatile byproducts remain in the molded product.

The molded product of the present invention can be suitably used in electronic components and electronic devices, and other materials (substrate materials for electronic device materials), in particular in multilayer substrates, laminated substrates, encapsulating agents, adhesive agents or the like for which excellent dielectric characteristics are required. The molded product of the present invention can also be used in aircraft members, automobile members, construction members and the like.

In the present invention, the term “electronic device” includes, for instance, IC cards, mobile phones, video cameras, computers, fax machines, digital cameras, vehicle onboard devices (GPS, car navigation devices or the like), PDAs, electronic organizers and the like. Such substrate materials for electronic device materials can be used in high-frequency circuit boards in computers, high-frequency circuit boards, or circuit boards comprising the same, in mobile phones, and as high-frequency circuit boards used in GPS and/or range radars, in vehicle onboard devices.

Due to high-speed operation, shorter delay times are necessary in high-frequency circuit boards, and hence there are required boards having low permittivity. At high frequencies, moreover, loss is directly proportional to frequency, and hence low dielectric loss is desirable. In GPS and range radars as well, low dielectric loss is desirable in terms of antenna gain. Electronic devices excellent in such desired characteristics can be achieved by using the above substrate material for electronic devices.

Typical examples of the present invention are explained below, although the invention is in no way meant to be limited to or by these examples.

### Examples A

### Example 1

Bisphenol A (Tokyo Kasei, 99%), in an amount of 18.45 g (0.08 mol), 3(4),8(9)-bis(aminomethyl)tricyclo[5,2,1,0^{2,6}]decane (Tokyo Kasei, 97%), in an amount of 16.03 g (0.08 mol), and paraformaldehyde (Wako Pure Chemical Industries, 94%) in an amount of 10.22 g (0.32 mol) were charged into chloroform, and were made to react for 6 hours under reflux. After the reaction, a polymer was precipitated through addition of excess methanol to the solution. The polymer was then separated by filtration, was washed with methanol, and was vacuum-dried. The polymer exhibited a weight-average molecular weight of 4,600 as measured by GPC based on standard polystyrene.

### Example 2

A polymer was synthesized as in Example 1 but using herein 1,1-bis(4-hydroxyphenyl)cyclohexane (Tokyo Kasei, 99%) in an amount of 21.69 g (0.08 mol) instead of bisphenol A. The weight-average molecular weight of the polymer was 3,800.

### Example 3

α,α′-bis(4-hydroxyphenyl)-1,4-diisopropylbenzene (same compound as bisphenol P, Tokyo Kasei, 98%) in an amount of 22.99 g (0.065 mol), 3(4),8(9)-bis(aminomethyl)tricyclo[5,2,1,0^{2,6}]decane (Tokyo Kasei, 97%) in an amount of 13.02 g (0.065 mol), and paraformaldehyde (Wako Pure Chemical Industries, 94%) in an amount of 8.31 g (0.26 mol) were charged into chloroform, and were made to react for 6 hours under reflux. After the reaction, a polymer was precipitated through addition of excess methanol to the solution. The polymer was then separated by filtration, was washed with methanol, and was then vacuum-dried. The polymer exhibited a weight-average molecular weight of 5,700 as measured by GPC based on standard polystyrene.

### Examples 4 to 6

The polymers obtained in Examples 1 to 3 were molded into sheets through heat-pressing, by being held at 140° C., 160° C. and 180° C., respectively, for 1 hour, to yield sheet-like cured molded products having a thickness of 0.5 mm.

The permittivity and the dielectric tangent of the obtained molded products were measured at 23° C., for 100 MHz and 1 GHz, in accordance with a capacitance method, using a permittivity measuring device (“RF impedance/material analyzer E4991A” by AGILENT).

The obtained sheets were finely cut and were tested for 5% weight reduction temperature (Td₅) by TGA, using an instrument “DTG-60” by Shimadzu, with a temperature rise rate of 10° C./minute.

The measurement/evaluation results are given in Table 1.

TABLE 1

| | | 100 MHz | | 1 GHz | | |
|---|---|---|---|---|---|---|
| | Polymer | | Dielectric | | Dielectric | |
| | used | Permittivity | tangent | Permittivity | tangent | Td₅ |
| Example 4 | Example 1 | 2.92 | 0.0035 | 2.91 | 0.0023 | 308° C. |
| Example 5 | Example 2 | 2.79 | 0.0032 | 2.79 | 0.0014 | 320° C. |
| Example 6 | Example 3 | 2.85 | 0.0043 | 2.85 | 0.0033 | 350° C. |

As Table 1 shows, the cured molded products of Examples 4 to 6 exhibited all good dielectric characteristics, with permittivity no greater than 3 and dielectric tangent no greater than 0.005. The cured molded products of Examples 4 to 6 exhibited moreover excellent Td₅ values, of 308° C. to 350° C.

### Example 7

A polymer was synthesized as in Example 1 but using herein 2,2-bis(4-hydroxy-3-methylphenyl)propane (Tokyo Kasei, 98%) in an amount of 20.93 g (0.08 mol) instead of bisphenol A. The weight-average molecular weight of the polymer was 4,300.

### Example 8

2,2-bis(4-hydroxyphenyl)hexafluoropropane (Tokyo Kasei, 99%) in an amount of 22.08 g (0.065 mol), 3(4),8(9)-bis(aminomethyl)tricyclo[5,2,1,0^{2,6}]decane (Tokyo Kasei, 97%) in an amount of 13.02 g (0.065 mol), and paraformaldehyde (Wako Pure Chemical Industries, 94%) in an amount of 8.72 g (0.27 mol) were charged into chloroform, and were made to react for 6 hours under reflux. After the reaction, a polymer was precipitated through addition of excess methanol to the solution. The polymer was then separated by filtration, was washed with methanol, and was vacuum-dried. The polymer exhibited a weight-average molecular weight of 5,900 as measured by GPC based on standard polystyrene.

### Example 9

A polymer was synthesized as in Example 8 but using herein 9,9-bis(4-hydroxyphenyl)fluorene (Tokyo Kasei, 98%) in an amount of 23.24 g (0.065 mol) instead of 2,2-bis(4-hydroxyphenyl)hexafluoropropane. The polymer exhibited a weight-average molecular weight of 7,000 as measured by GPC based on standard polystyrene.

### Example 10

Bisphenol A (Tokyo Kasei, 99%) in an amount of 18.45 g (0.065 mol), 2,5(6)-bis(aminomethyl)bicyclo[2,2,1]heptane (Mitsui Chemicals, 99.8%) in an amount of 12.37 g (0.08 mol), and paraformaldehyde (Wako Pure Chemical Industries, 94%) in an amount of 10.73 g (0.34 mol) were charged into chloroform, and were made to react for 6 hours under reflux. After the reaction, a polymer was precipitated through addition of excess methanol to the solution. The polymer was then separated by filtration, was washed with methanol, and was vacuum-dried. The polymer exhibited a weight-average molecular weight of 5,600 as measured by GPC based on standard polystyrene.

### Example 11

A polymer was synthesized as in Example 10 but using herein 1,1-bis(4-hydroxyphenyl)cyclohexane (Honshu Chemical, 99.9%) in an amount of 21.49 g (0.08 mol) instead of bisphenol A. The polymer exhibited a weight-average molecular weight of 5,000 as measured by GPC based on standard polystyrene.

### Example 12

A polymer was synthesized as in Example 8 but using herein 1,1-bis(4-hydroxyphenyl)-1-phenylethane (Tokyo Kasei, 98%) in an amount of 18.89 g (0.065 mol) instead of 2,2-bis(4-hydroxyphenyl)hexafluoropropane. The polymer exhibited a weight-average molecular weight of 4,900 as measured by GPC based on standard polystyrene.

### Example 13

A polymer was synthesized as in Example 1 but using herein 1,1-bis(4-hydroxyphenyl)ethane (Tokyo Kasei, 98%) in an amount of 17.49 g (0.08 mol) instead of bisphenol A. The weight-average molecular weight of the polymer was 5,200.

### Example 14

A polymer was synthesized as in Example 8 but using herein bisphenol M (Mitsui Chemicals, 99.5%) in an amount of 22.63 g (0.065 mol) instead of 2,2-bis(4-hydroxyphenyl)hexafluoropropane. The polymer exhibited a weight-average molecular weight of 6,100 as measured by GPC based on standard polystyrene.

### Example 15

A polymer was obtained as in Example 3 but using herein 2,5(6)-bis(aminomethyl)bicyclo[2,2,1]heptane (Mitsui Chemicals, 99.8%) in an amount of 10.05 g (0.065 mol) instead of 3(4),8(9)-bis(aminomethyl)tricyclo[5,2,1,0^{2,6}]decane. The weight-average molecular weight of the polymer was 6,600.

### Example 16

A thermosetting composition solution was prepared by dissolving 100 parts by weight of the polymer obtained in Example 1 and 50 parts by weight of Epicoat #1007 (bisphenol A-type epoxy resin, by Japan Epoxy Resin) in 100 parts by weight of THF. The thermosetting composition solution was cast on a PET film and the THF was removed by drying to yield a 150 μm-thick film comprising the thermosetting composition.

### Example 17

The film obtained in Example 16 was heated in an oven at 140° C. for 1 hour, 160° C. for 1 hour, and 180° C. for 1 hour, to yield a cured film. Upon measurement of the dielectric characteristics, the cured film exhibited comparatively good dielectric characteristics, with a permittivity of 2.95 and a dielectric tangent of 0.013 at 100 MHz, and a permittivity of 2.90 and a dielectric tangent of 0.012 at 1 GHz. The film obtained in Example 4 whitened as a result of a 1800 bending test. The film obtained in Example 16, by contrast, having been imparted pliability, was unproblematic, remaining transparent without fold-line whitening in a 1800 bending test. In the bending test, the sample film was folded in two to a width of 10 mm, and then both sides were pressed together under a force of 3 kgf. Thereafter, the film was spread out for evaluation and was rated on the basis only of the presence of a fold line, into ◯ for transparency, Δ for whitening, and x for film breakage.

### Example 18

An uncured film was prepared following the same procedure as in Example 16, but using herein 100 parts by weight and 200 parts by weight as the blending ratio of Epicoat #1007, instead of 100 parts by weight. The film was then subjected to a thermal treatment for 1 hour each at 140° C., 160° C. and 180° C., to yield cured films. The dielectric characteristics (permittivity ∈ and dielectric loss tan δ) of the obtained cured films were evaluated. The results were as follows.

Evaluation Results

| | at 100 MHz | at 1 GHz |
|---|---|---|
| Example 18-a | ε 3.00 tanδ 0.017 | ε 2.94 tanδ 0.015 |
| (100 parts by weight) | | |
| Example 18-b | ε 3.08 tanδ 0.021 | ε 2.98 tanδ 0.019 |
| (200 parts by weight) | | |

Both cured films were rated as 0 in the above bending test.

### Example a1

### Synthesis of Polyamic Acid

Polyamic acid was obtained by adding the monomers below to 3762 g of dehydrated N-methyl-2-pyrrolidone using a molecular sieve 4A, to dissolve the monomers, under nitrogen stream, with stirring to homogeneity over 3 hours at a stirring speed of 150 rpm using a stirrer.
pyromellitic anhydride, 218 g (1 mol)
4,4′-diaminodiphenyl ether 200 g (1 mol)

Preparation of a Plate-Like Molded Product

The polymer obtained in Example 1 was added to the polyamic acid prepared as described above, to a solids ratio of 10 wt %, followed by thorough stirring/shaking to yield a homogeneous solution.

The obtained mixed solution was applied onto a polyethylene terephthalate (PET) sheet using an applicator, and then most of the solvent was removed by holding the temperature at 100° C. for 1 hour in a nitrogen atmosphere. Thereafter, benzoxazine polymerization and polyimide generation through ring opening of polyamic acid were carried out simultaneously by sequential heating at 150° C. for 1 hour, and at 200° C. for 1 hour, to prepare a plate-like molded product having a thickness of 50 μm.

Measurement of Permittivity and Dielectric Tangent

Specimens were cut out of the plate-like molded products obtained in the above examples and comparative examples. The properties of the specimens were measured in accordance with the following protocols.

Specimens were cut out to a size of 15 mm×15 mm from the obtained 50 μm-thick molded products. The permittivity and dielectric tangent at 100 MHz of the specimens were measured at 23° C. by setting the specimens in a permittivity measurement device (“HP 4291B”, by Hewlett Packard). As a result there were obtained a permittivity of 3.21 and a dielectric tangent of 0.0038. All the films were rated as 0 in the above bending test.

The permittivity and the dielectric tangent of the same samples were measured again at 23° C., for 100 MHz and 1 GHz, in accordance with a capacitance method, using a permittivity measuring device (“RF impedance/material analyzer E4991A” by AGILENT). As a result there were obtained a permittivity of 3.21 and a dielectric tangent of 0.0037.

### Example 19

An uncured film was prepared following the same procedure as in Example 16, but using herein, respectively, 20 parts by weight, 50 parts by weight and 100 parts by weight of NC3000H (biphenyl-type epoxy resin, by Nippon Kayaku) instead of Epicoat #1007. The film was then subjected to a thermal treatment for 1 hour each at 140° C., 160° C. and 180° C., to yield a cured film. The dielectric characteristics of the obtained cured films were evaluated, to yield the following results.

Evaluation Results

| | at 100 MHz | at 1 GHz |
|---|---|---|
| Example 19-a | ε 3.04 tanδ 0.006 | ε 3.01 tanδ 0.006 |
| (20 parts by weight) | | |
| Example 19-b | ε 3.08 tanδ 0.009 | ε 3.04 tanδ 0.009 |
| (50 parts by weight) | | |
| Example 19-c | ε 3.21 tanδ 0.012 | ε 3.14 tanδ 0.015 |
| (100 parts by weight) | | |

All the films were rated as 0 in the above bending test.

### Examples 20 and 21

The polymers obtained in Examples 10 and 15 were molded into sheets through heat-pressing, by being held at 180° C. for 1 hour, to yield sheet-like cured molded products having a thickness of 0.5 mm.

The permittivity, dielectric tangent and thermal decomposition characteristics by TGA of the obtained molded products were evaluated in the same way as those of Examples 4 to 6. The results are summarized in Table 2

TABLE 2

| | | 100 MHz | | 1 GHz | | |
|---|---|---|---|---|---|---|
| | Polymer | | Dielectric | | Dielectric | |
| | used | Permittivity | tangent | Permittivity | tangent | Td₅ |
| Example 20 | Example 10 | 2.79 | 0.0012 | 2.80 | 0.0012 | 324° C. |
| Example 21 | Example 15 | 2.83 | 0.0023 | 2.83 | 0.0030 | 315° C. |

### Examples 22 to 23

CTE, Td₅ and bending test were evaluated for the various examples below, in which R² of formula (II) was —(CH₂)ᵢ—, R¹ was a group represented by (i) below, m was the proportion (%) described below, and in which i and m were changed into various combinations.

Permeability and dielectric tangent were also measured.

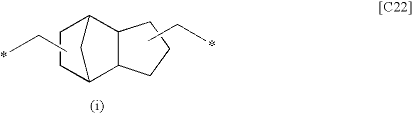

m(%)=[mole ratio of R²/(mole ratio of R¹+mole ratio of R²]×100 [Equation 1]

Measurement of CTE (ppm/° C.) (CTE Denotes the Rate of Expansion of a Material Versus Temperature)

Samples having a thickness of 75 to 100 μm and a width of 4 mm were tested for elongation versus temperature, at 23 to 100° C., using a TMA (thermomechanical analyzer) device DMS 6100 from SII (SII Nanotechnology Inc).

Bending Test

In the bending test, the sample film was folded in two to a width of 10 mm and a thickness of 75μ, and then both sides were pressed together under a force of 3 kgf. Thereafter, the film was spread out for evaluation and was rated on the basis only of the presence of a fold line, into ◯ for transparency, Δ for whitening, and x for film breakage.

Measurement of Permittivity and Dielectric Tangent

The polymers obtained in Examples 22 to 23 were molded into sheets through heat-pressing, by being held at 140° C., 160° C. and 180° C., respectively, for 1 hour, to yield sheet-like cured molded products having a thickness of 0.5 mm.

The permittivity and the dielectric tangent of the obtained molded products were measured at 23° C., for 100 MHz and 1 GHz, in accordance with a capacitance method, using a permittivity measuring device (“RF impedance/material analyzer E4991A” by AGILENT).

Measurement of 5% Weight Reduction Temperature (Td₅)

The obtained sheets were finely cut and were tested for 5% weight reduction temperature (Td₅) by TGA, using an instrument “DTG-60” by Shimadzu, with a temperature rise rate of 10° C./minute.

The results of the above tests were as follows.

| | | m | CTE | | Bending | Thickness | Permittivity | |
|---|---|---|---|---|---|---|---|---|
| | i | (%) | (ppm/° C.) | Td₅ | test | (μ) | (100 MHz) | tanδ |
| Example 22 | 2 | 50 | 58 | 284 | x | 82 | 2.85 | 0.003 |
| Example 23 | 4 | 50 | 58 | 311 | x | 83 | 2.78 | 0.003 |
| Example 24 | 6 | 50 | 59 | 321 | ∘ | 84 | 2.79 | 0.005 |
| Example 25 | 8 | 50 | 77 | 326 | ∘ | 82 | 2.80 | 0.006 |
| Example 26 | 12 | 50 | 125 | 331 | ∘ | 88 | 2.77 | 0.005 |
| Example 27 | 6 | 0 | 57 | 337 | Δ | 82 | 2.69 | 0.002 |
| Example 28 | 6 | 10 | 68 | 331 | Δ | 83 | 2.77 | 0.004 |
| Example 29 | 6 | 25 | 67 | 324 | ∘ | 85 | 2.84 | 0.004 |
| Example 30 | 6 | 50 | 59 | 321 | ∘ | 84 | 2.79 | 0.005 |
| Example 31 | 6 | 75 | 64 | 320 | ∘ | 88 | 2.73 | 0.007 |
| Example 32 | 6 | 90 | 70 | 311 | ∘ | 80 | 2.95 | 0.008 |
| Example 33 | 6 | 100 | 72 | 312 | ∘ | 85 | 2.84 | 0.006 |

The above results indicate the following.

In terms of CTE, the number of carbon atoms is preferably no greater than 8, more preferably no greater than 6.

In terms of Td₅, the number of carbon atoms is preferably no smaller than 6. In the case of C6, m is preferably no greater than 75%, more preferably no greater than 50%.

For C6, m is preferably no smaller than 10%, more preferably no smaller than 25%, in terms of breakage (bending test).

### Examples B

### Example B-1

Bisphenol A (Tokyo Kasei, 99%) in an amount of 18.45 g (0.08 mol), 3(4),8(9)-bis(aminomethyl)tricyclo[5,2,1,0^{2,6}]decane (Tokyo Kasei, 97%) in an amount of 8.01 g (0.04 mol), 1,12-dodecanediamine (Wako Pure Chemical Industries, 97%) in an amount of 8.26 g (0.04 mol), and paraformaldehyde (Wako Pure Chemical Industries, 94%) in an amount of 10.73 g (0.34 mol) were charged into chloroform, and were made to react for 6 hours under reflux. After the reaction, a polymer was precipitated through addition of excess methanol to the solution. The polymer was then separated by filtration, was washed with methanol, and was vacuum-dried. The polymer exhibited a weight-average molecular weight of 16,600 as measured by GPC based on standard polystyrene.

### Example B-2

α,α′-bis(4-hydroxyphenyl)-1,4-diisopropylbenzene (Tokyo Kasei, 98%) in an amount of 22.98 g (0.065 mol), 3(4),8(9)-bis(aminomethyl)tricyclo[5,2,1,0^{2,6}]decane (Tokyo Kasei, 97%) in an amount of 6.51 g (0.0325 mol), 1,12-dodecanediamine (Wako Pure Chemical Industries, 97%) in an amount of 6.71 g (0.0325 mol) and paraformaldehyde (Wako Pure Chemical Industries, 94%) in an amount of 8.72 g (0.27 mol) were charged into chloroform, and were made to react for 6 hours under reflux. After the reaction, a polymer was precipitated through addition of excess methanol to the solution. The polymer was then separated by filtration, was washed with methanol, and was vacuum-dried. The polymer exhibited a weight-average molecular weight of 12,200 as measured by GPC based on standard polystyrene.

### Example B-3

A polymer was synthesized as in Example B-2 but using herein bisphenol M (Mitsui Chemicals, 99.5%) in an amount of 22.63 g (0.065 mol) instead of α,α′-bis(4-hydroxyphenyl)-1,4-diisopropylbenzene. The weight-average molecular weight of the polymer was 24,500.

### Example B-4

Bisphenol A (Tokyo Kasei, 99%) in an amount of 18.45 g (0.08 mol), 3(4),8(9)-bis(aminomethyl)tricyclo[5,2,1,0^{2,6}]decane (Tokyo Kasei, 97%) in an amount of 16.03 g (0.08 mol), and paraformaldehyde (Wako Pure Chemical Industries, 94%) in an amount of 10.22 g (0.32 mol) were charged into chloroform, and were made to react for 6 hours under reflux. After the reaction, a polymer was precipitated through addition of excess methanol to the solution. The polymer was then separated by filtration, was washed with methanol. The polymer having the structure below was obtained then through vacuum-drying. The polymer exhibited a weight-average molecular weight of 4,600 as measured by GPC based on standard polystyrene.

### Example B-5

A polymer was synthesized as in Example B-1 but using herein 1,1-bis(4-hydroxyphenyl)cyclohexane (Tokyo Kasei, 99%) in an amount of 21.69 g (0.08 mol) instead of bisphenol A. The weight-average molecular weight of the polymer was 3,800.

### Example B-6

α,α′-bis(4-hydroxyphenyl)-1,4-diisopropylbenzene (same compound as bisphenol P, Tokyo Kasei, 98%) in an amount of 22.99 g (0.065 mol), 3(4),8(9)-bis(aminomethyl)tricyclo[5,2,1,0^{2,6}]decane (Tokyo Kasei, 97%) in an amount of 13.02 g (0.065 mol), and paraformaldehyde (Wako Pure Chemical Industries, 94%) in an amount of 8.31 g (0.26 mol) were charged into chloroform, and were made to react for 6 hours under reflux. The reaction scheme is indicated below. After the reaction, a polymer was precipitated through addition of excess methanol to the solution. The polymer was then separated by filtration, and was washed with methanol. The polymer having the structure below was obtained then through vacuum-drying. The polymer exhibited a weight-average molecular weight of 5,700 as measured by GPC based on standard polystyrene.

Measurement of Permittivity and Dielectric Tangent

The polymers obtained in Examples B-2 and 4 to 6 were molded into sheets through heat-pressing, by being held at 140° C., 160° C. and 180° C., respectively, for 1 hour, to yield sheet-like cured molded products having a thickness of 0.5 mm.

The permittivity and the dielectric tangent of the obtained molded products were measured at 23° C., for 100 MHz and 1 GHz, in accordance with a capacitance method, using a permittivity measuring device (“RF impedance/material analyzer E4991A” by AGILENT).

Measurement of 5% Weight Reduction Temperature (Td₅)

The obtained sheets were finely cut and were tested for 5% weight reduction temperature (Td₅) by TGA, using an instrument “DTG-60” by Shimadzu, with a temperature rise rate of 10° C./minute.

Bending Test

In the bend test, the sample film was folded in two to a width of 10 mm and a thickness of 75μ, and then both sides were pressed together under a force of 3 kgf using the polymers obtained in Examples B-2 and 4 to 6. Thereafter, the film was spread out for evaluation and was rated on the basis only of the presence of a fold line, into ◯ for transparency, Δ for whitening, and x for film breakage

The measurement/evaluation results are given in Table 3.

TABLE 3

| | 100 MHz | | 1 GHz | | | |
|---|---|---|---|---|---|---|
| | Permit- | Dielectric | Permit- | Dielectric | | Flexi- |
| | tivity | tangent | tivity | tangent | Td₅ | bility |
| Example B-2 | 2.82 | 0.0041 | 2.80 | 0.0034 | 316° C. | ∘ |
| Example B-4 | 2.92 | 0.0035 | 2.91 | 0.0023 | 308° C. | Δ |
| Example B-5 | 2.79 | 0.0032 | 2.79 | 0.0014 | 320° C. | Δ |
| Example B-6 | 2.85 | 0.0043 | 2.85 | 0.0033 | 350° C. | Δ |

As Table 3 shows, the cured molded products of Example B-2 exhibited good dielectric characteristics, with permittivity no greater than 3 and dielectric tangent no greater than 0.005, exhibited also extremely good Td₅, of 316° C., and had also excellent pliability.

The films obtained in Examples B-4 to 6 whitened as a result of a 1800 bend test. The film obtained in Example B-2, by contrast, having been imparted pliability, was unproblematic and remained transparent without exhibiting fold-line whitening in a 1800 bending test.

The present invention has industrial applicability in that it provides a thermosetting resin that combines excellent dielectric characteristics and heat resistance, or a thermosetting resin that combines excellent dielectric characteristics, heat resistance and pliability, as well as a thermosetting composition comprising the thermosetting resin, and a molded product, cured product, and cured molded product obtained from the thermosetting resin.

I (We) claim:

1. A thermosetting resin having a dihydrobenzoxazine ring structure represented by formula (I) in a main chain thereof, 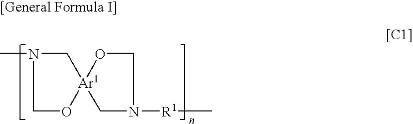
(in formula (I), Ar¹ represents a tetravalent aromatic group, R¹ is a hydrocarbon group having a fused alicyclic structure, and n represents an integer from 2 to 500).

2. The thermosetting resin according to claim 1, wherein R¹ is a group represented by (i) or (ii), 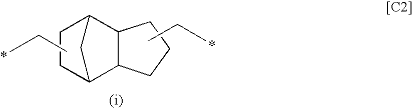
(in formula (I), the * sign represents a bonding site to N; the formula includes cis-trans isomers), 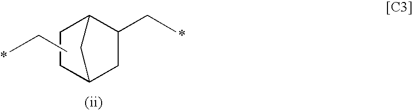
(in formula (II), the * sign represents a bonding site to N; the formula includes cis-trans isomers).

3. The thermosetting resin according to claim 1, wherein Ar¹ is represented by any of structures (iii), (iv) or (v), 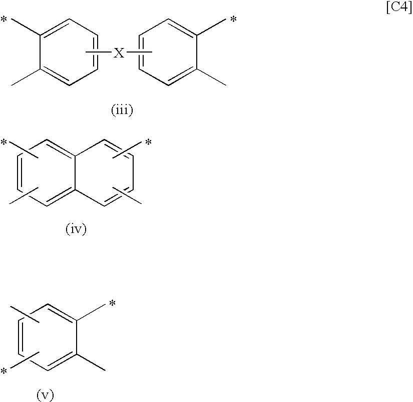
(in formulas (iii) to (v), the * sign represents a bonding site to OH, and the other sign a bonding site to a methylene group at position 4 of an oxazine ring;
hydrogen in the aromatic rings may be substituted with a C₁ to C₁₀ aliphatic hydrocarbon group, alicyclic hydrocarbon group, or a substituted or unsubstituted phenyl group;
in formula (iii), X denotes a direct bond (without any atom or atom groups), or an aliphatic, alicyclic or aromatic hydrocarbon group optionally comprising a heteroelement or functional group).

4. The thermosetting resin according to claim 3, wherein Ar¹ is represented by the structure (iii) and X in the structure (iii) is at least one selected from group A below,
[C5]
group A: 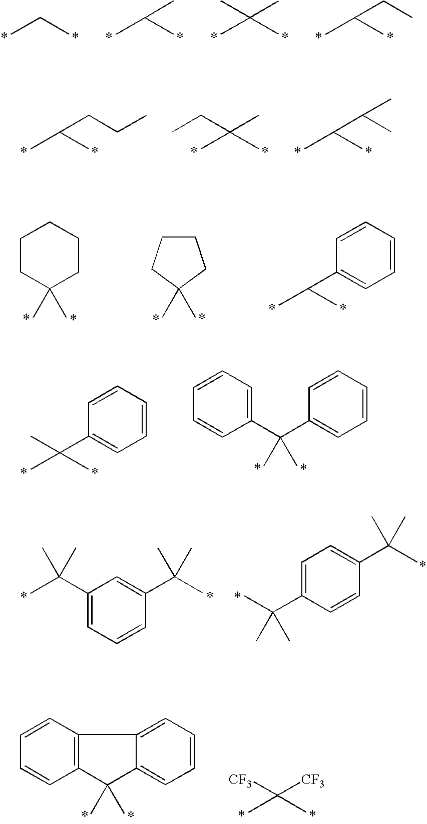
(in the formula, the * sign represents a bonding site to an aromatic ring of the structure (iii)).

5. A thermosetting resin having a dihydrobenzoxazine ring structure represented by formula (II) in a main chain thereof, 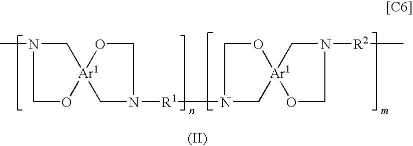
(in formula (II), Ar¹ represents a tetravalent aromatic group, R¹ is a hydrocarbon group having a fused alicyclic structure, R² is an aliphatic hydrocarbon group, and m+n represents an integer from 2 to 500).

6. The thermosetting resin according to claim 5, wherein R² is a linear aliphatic hydrocarbon group.

7. The thermosetting resin according to claim 5, wherein R² is a C₆ to C₁₂ aliphatic hydrocarbon group.

8. The thermosetting resin according to claim 5, wherein R¹ is a group represented by (i) or (ii), 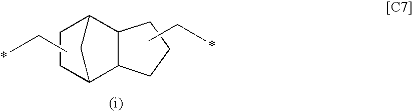
(in formula (I), the * sign represents a bonding site to N; the formula includes cis-trans isomers), 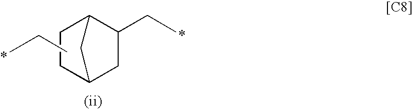
(in formula (II), the * sign represents a bonding site to N; the formula includes cis-trans isomers).

9. The thermosetting resin according to claim 5, wherein Ar¹ is represented by any of structures (iii), (iv) or (v), 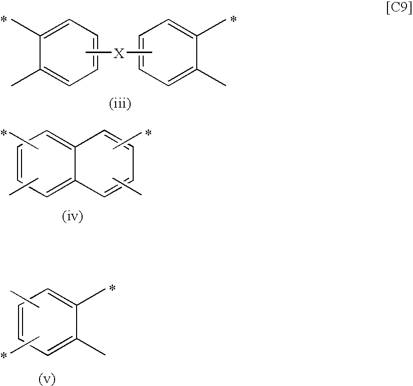
(in formulas (iii) to (v), the * sign represents a bonding site to OH, and the other sign a bonding site to a methylene group at position 4 of an oxazine ring;
hydrogen in the aromatic rings may be substituted with a C₁ to C₁₀ aliphatic hydrocarbon group, alicyclic hydrocarbon group, or a substituted or unsubstituted phenyl group;
in formula (iii), X denotes a direct bond (without any atom or atom groups), or an aliphatic, alicyclic or aromatic hydrocarbon group optionally comprising a heteroelement or functional group).

10. The thermosetting resin according to claim 9, wherein Ar¹ is represented by the structure (iii) and X in the structure (iii) is at least one selected from group A below, 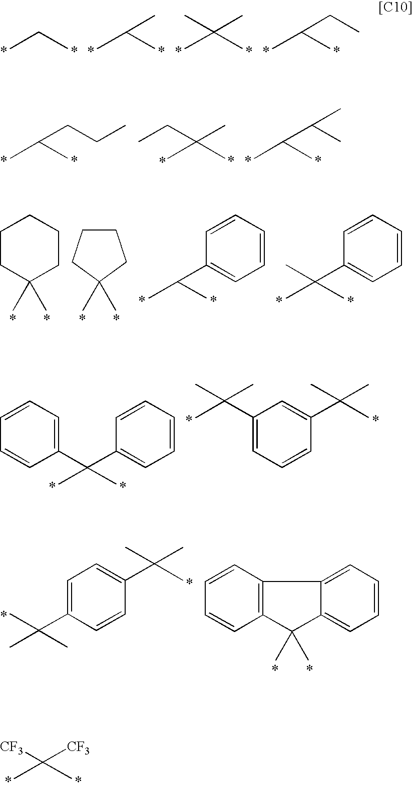
(in the formula, the * sign represents a bonding site to an aromatic ring of the structure (iii)).

11. A thermosetting resin having a dihydrobenzoxazine ring structure in a main chain thereof, obtained by reacting:
(1) an aliphatic diamine represented by NH₂—R²—NH₂ (R² is an aliphatic hydrocarbon group);
(2) OH—Ar²—OH (Ar² is an aromatic group);
(3) NH₂—R¹—NH₂(R¹ is a hydrocarbon group having a fused alicyclic structure); and
(4) an aldehyde compound.

12. A thermosetting composition comprising at least the thermosetting resin according to any one of claims 1, 5 and 11.

13. The thermosetting composition according to claim 12, comprising a compound having at least one dihydrobenzoxazine structure in the molecule.

14. A molded product obtained from the thermosetting resin according to any one of claims 1, 5 and 11.

15. A molded product obtained from the thermosetting composition according to claim 12.

16. A cured product obtained by curing the thermosetting resin according to any one of claims 1, 5 and 11.

17. A cured product obtained by curing the thermosetting composition according to claim 12.

18. A cured molded product obtained by curing the molded product according to claim 14.

19. A cured molded product obtained by curing the molded product according to claim 15.
